(19) United States
(12) Patent Application Publication
(10) Pub. No.: US 2013/0009403 A1
(43) Pub. Date: Jan. 10, 2013

(54) Wind powered electrical generator-hydraulic-natural gas power augmented

(76) Inventor: Steven Louis Cornelius, Taft, TN (US)

(21) Appl. No.: 13/135,476

(22) Filed: Jul. 7, 2011

(51) Int. Cl. F03D 9/00

(52) U.S. Cl. 290/55

(57) ABSTRACT

Natural gas (NG) fueled auxiliary power source, combined with a high-pressure hydraulic pump supplying hydraulic fluid to a secondary hydraulic propulsion unit mounted (hung) on the rear (aft) of the wind generator main shaft provides axial force (torque) to the mainshaft via a ring and pinion set and planetary gearbox, or scaled turbine propulsion unit equipped with shaft speed sensors that have been calibrated to minimum/maximum desired main shaft (electrical generator) speed and that can engage and spin the main shaft attached to the electrical power generator on demand when there is insufficient wind to do so.

### CROSS REFERENCE TO RELATED APPLICATION

NONE

### STATEMENT REGARDING FEDERALLY SPONSORED RESEARCH OR DEVELOPMENT

No Federal research or development funds were used in the development of this concept/product.

### THE NAMES OF TILE PARTIES TO A JOINT RESEARCH AGREEMENT

N/A

### INCORPORATION-BY-REFERENCE OF MATERIAL SUBMITTED ON A COMPACT DISC

N/A

### BACKGROUND OF THE INVENTION

The current generation of wind powered electrical generators is completely dependent upon a sufficient velocity of wind driving their massive propellers, thereby rotating the main throughput shaft which is connected to an electrical generator, spinning the generator which in turn produces electricity for consumer use. The uncertainty of achieving consistent wind velocity and direction has been the historical and primary limiting factor inhibiting large-scale adaption of wind power to augment the national electrical grid and provide a reliable and renewable energy source.

One proposed solution to provide a more consistent wind power supply is to incorporate an efficient natural gas powered engine, driving a hydraulic power unit mounted behind the power generation assembly (on the aft or non-wind end of the power cab) as an alternate locomotive source to turn the electrical generator. The entire auxiliary propulsion system would consist of: 1) a natural gas engine; 2) a high pressure hydraulic pump driven by the natural gas powered engine; 3) a pressure accumulation (storage) tank with associated check and release valves calibrated to the pressure range required to power the propulsion unit; 4) a particulate filter to remove foreign matter from the fluid as it flows through the closed-loop hydraulic system to the reservoir for use by the hydraulic pump; 5) a control panel linked to the sensors mounted on the main generator shaft, and; 6) a hydraulic propulsion system connected to the hydraulic pump via high-pressure lines (hydraulic fluid supply and return). Items 1 through 4 would be mounted at the base of the wind turbine assembly. Item 5 would be mounted inside the base unit. Item 6 (the natural gas engine driven hydraulic pump/hydraulic propulsion system) is mounted inside the power generation cab on top of the elevation mast.

The natural gas engine drives the hydraulic pump which propels hydraulic fluid through a high-pressure connecting line. The hydraulic fluid goes directly to the hydraulic drive motor on the generator. The hydraulic accumulator (which is located in the ground-level building) has a membrane or piston separating the air and oil side, and acts as a pressure pre-load system, and overflow outlet for fluid and back-up supply source. A variable-displacement hydraulic motor mounted inside the power cab (atop the mast) employs a swashplate control and return valves to increase inherent system control and in some applications, may obviate the need for a separate viscous coupling. Another advantage of using swashplate control and return valves is that these control mechanisms would allow the mainshaft to “freewheel” in the depressurized (0 swashplate angle) mode, reducing hydraulic fluid cooling requirements and overall drag on the system when under wind power. Similar control schemes are used in hydraulic systems and hydraulic-driven electrical generators (the constant-speed generators) employed on many aircraft engines.

A water to oil heat exchanger assembly will be integrated into the hydraulic fluid return line to maintain hydraulic fluid temperatures within specified limits. The heat exchanger will be mounted alongside the radiator, which cools the natural gas engine. A one-way check valve is calibrated to the highest specific pressure needed by the propulsion unit will act as a safety override mechanism that shuts off hydraulic fluid flow from the pump. If maximum pressure thresholds are exceeded, the check valve and incorporated pressure sensor simultaneously sends a cut-off signal to the natural gas engine to prevent damage to the accumulator tank and hydraulic lines from over-pressurization. The check valve will be incorporated on the high-pressure supply line.

The combination of the following components: a constant-pressure, variable-displacement hydraulic pump on the gas engine; constant-speed, variable-displacement hydraulic drive motor; individual controllers on each, would take care of all but the most excessive load/speed transients. The clutch/controller on the planetary gear set will act as a secondary mechanism to compensate for engagement load/speed transients above 150% of design load capacity (when the hydraulic motor engages/disengages). Sudden, high-pressure shocks to the various connection joints and propulsion system could cause instantaneous component failure (metal fatigue or shearing) and certainly would reduce the service life of critical components. To ensure that hydraulic fluid used in the closed-loop system remains free of contaminants, an inline filter will be mounted on the return (low-pressure) line as part of the base unit assembly—for ease of maintenance.

The hydraulic propulsion system will consist of a ring and pinion gear assembly, planetary gearbox to increase torque, viscous coupling and harmonic damping flywheel to absorb start/stop engine shock and sensors to monitor shaft speed. The ring gear is impelled by the rotation of the pinion assembly, which translates hydraulic pressure into (right angle) rotational force. The pinion translates right angle motion into torque which spins the ring gear which, in turn, spins the planetary gear assembly. The ratios for the planetary gear set may be varied as required to provide sufficient torque to spin the main generator shaft at specified RPM to meet specified output demand (rated power or peak usage demand). The entire hydraulic propulsion system, including the natural gas engine, is controlled by a series of speed sensors and auto start/stop actuators synchronized, programmed and controlled by the Master Control Panel to work in unison.

The hydraulic propulsion system would automatically send power via a viscous coupling and planetary gear set that engage and turn the electrical generator shaft when wind velocity isn't sufficient to ensure that main shaft revolutions per minute (RPM) remain within generator manufacturer's recommended speed range (minimum speed necessary to generate rated electrical output). The most likely condition causing the auxiliary propulsion system to engage would be insufficient wind velocity (calm days) or gusting velocities that exceed rated rotational speed of the propeller assembly (unpredictable weather/storm conditions), which would fail to turn the main generator shaft at the required RPM to assure specified/rated electrical output. A propeller feathering mechanism could also be incorporated to prevent damage to the large propeller assembly during extremely high winds (storm conditions).

The auxiliary propulsion system would be controlled by employing the latest technology available (sensors, controllers and actuators) that have accrued hundreds of thousands of hours of all-weather use in automotive and aircraft industry applications. Symmetrical sets of sensors, controllers and actuators would be mounted within a control box co-located with the natural gas engine and the hydraulic propulsion unit at the power generator base. The other set of sensors will be mounted on the hydraulic propulsion unit and generator main shaft in the power generation cab atop the mast assembly. All sensors will be capable of calibration to specific generator/applications, as needed and form an integral components comprising the redundant system for shaft speed monitoring and control. The matched (paired) shaft-mounted components sense decreases in speed and provide commands to the natural gas engine/high-pressure hydraulic pump to engage, begin spinning the pinion gear and thusly rotate the ring gear, which is connected to the planetary gear assembly, which in-turn, turns the main shaft axially in absence of wind.

This apparatus ensures instantaneous “on demand” power augmentation to maintain generator shaft RPM in the optimal electricity generating range (peak demand satisfaction or rated output) specified by the generator manufacturer. The sensors and actuators used are extremely rugged, small and have the added benefit of drawing very low voltage when in operation (12v DC).

If the generator shaft RPM drops below the lowest acceptable RPM for demand/rated power generation (250 RPM, for example), a series of redundant electro-magnetic induction (shaft) speed sensors mounted on the generator main shaft (FIG. #2, page 31) would immediately sense a reduction in shaft speed to below the calibrated rotational speed range and transmit an electrical signal to the main hydraulic propulsion system control unit, thereby triggering the natural gas powered aux engine to start-up, come on line and spin the hydraulic pump unit which would then provide a pre-specified volume of high-pressure hydraulic fluid via a delivery line to the hydraulic power unit mounted on center-line axis behind the electrical power generator.

The hydraulic pressure supplied to the power unit via the hydraulic pump would be translated into rotational force via a pinion and ring gear set or via a vaned turbine unit mounted on the generator mainshaft that is turned directly by hydraulic pressure from the hydraulic pump line. The vaned turbine unit would be a more compact and economical approach for low to medium power generation (10 kW to 100 kW range), while the ring and pinion application would be more suitable to megawatt range power generation requirements, because the gearset can be stepped as needed to match torque requirements to spin the electrical generator at the specified revolutions per minute (RPM) to produce rated electrical output.

The pinion gear would engage and turn the axially mounted ring gear which provides rotational force (torque) to the planetary gear system, viscous coupling box and damping flywheel. The aux engine and generator mainshaft will be fitted with electromagnetic (induction) rotational speed sensors and auto-start/stop technology (FIG. #2, page 31), that is very similar to the sensors and controller mechanisms currently employed in hybrid electric-gas automobiles to instantly start-up, engage and then cut-off when not needed, as well as activate and deactivate natural gas engine cylinders for optimum economy of operation during periods of light power demand by the electric generator.

This patent submission represents a proposed solution to this national problem.

### FIELD OF THE INVENTION

318 ELECTRICITY: MOTIVE POWER SYSTEMS

### DESCRIPTION OF THE RELATED ART INCLUDING INFORMATION

DISCLOSED UNDER 37 CFR 1.97 AND CFR1.98

ART UNIT: 2834

### BRIEF SUMMARY OF INVENTION

Incorporate (mount) a natural gas powered engine and hydraulic propulsion pump (built from aluminum and cast iron components) equipped with auto start/stop switching and monitored/controlled by primary and secondary control panels mounted at the base of a wind-power generation unit and the power generation cab, respectively. The base unit and primary control panel would be housed in an all-weather utility building, while the secondary control panel would be integrated/installed inside the power generation cab—located atop the generator support mast. Sensors for monitoring main shaft revolutions per minute (RPM) would be adapted from those that have been widely utilized within the automobile industry. The hydraulic power unit would be connected via one of two secondary propulsion mechanisms: 1) a two-stage drive system to the main turbine shaft of the wind powered electrical generator. The two-stage drive system consists of a ring and pinion gearset and a torque multiplying planetary gearbox; 2) via a vaned turbine unit mounted on the generator mainshaft that is turned directly by hydraulic pressure from the hydraulic pump line. The vaned turbine unit would be a more compact and economical approach for low to medium power generation (10 kW to 100 kW range), while the ring and pinion application would be more suitable to megawatt range power generation requirements, because the gearset can be stepped as needed to match torque requirements to spin the electrical generator at the specified revolutions per minute (RPM) to produce rated electrical output.

The auxiliary engine will burn natural gas (NG) supplied by pipeline or compressed natural gas (CNG) via a high pressure storage tank scaled to monthly fuel burn rates as the secondary fuel for wind powered electrical generators (wind being the primary locomotive force), but other fuel sources (propane, diesel, gasoline, kerosene, etc.) would work just as well, though overall cost per hour of generator operation would increase as would pollutant emissions, depending upon fuel choice and availability.

The output range (horsepower) for the engine (FIG. #1, page 30), can be specifically calibrated to the output requirement of the electrical generator and need to maintain desired/specified shaft revolutions per minute (RPM) to obtain optimal electric power output from the generator. The CNG engine will be equipped with all necessary environmental and system related sensors, monitors and switches configured for this application (FIG. #2, page 31), and installed on the auxiliary unit to detect insufficient wind (based upon main shaft—RPM) to turn the main shaft and generate electricity, providing sustaining power to maintain minimum RPM necessary to generate electricity at the rated output level specified by the generator manufacturer.

The engine is connected to a variable-displacement hydraulic pump where applicable/desirable via a direct, viscous coupling designed to absorb engine start-up/shut-down forces (FIG. #2, page 31). This engineering approach allows the engine to run at a single speed (or an array of pre-specified speeds, depending on load) so it could be tuned to the most optimum speed range. Two hydraulic fluid lines (supply and return) connect to the hydraulic propulsion unit, which spins the generator mainshaft through a ring and pinion assembly connected to a planetary gear system which multiplies engine torque, allowing a smaller more efficient engine to provide locomotive power (the design is very similar to those used on state-of-the-art, full-time all wheel drive and hybrid vehicles).

This approach allows power to be efficiently applied to the main generator shaft as needed and also to freewheel when not in use, eliminating drag or resistance on the main shaft when the hydraulic power/propulsion system (auxiliary engine and hydraulic pump assembly) isn't engaged. Matching the variable-displacement pump operating at the base unit is a similar (variable-displacement) hydraulic motor (propulsion unit) mounted inside the power cab (up top) will have enough inherent control via the swashplate control and return valves to obviate a separate viscous coupling. The swashplate valves would also “freewheel” in the depressurized (0 swashplate angle) mode, reducing cooling requirements. This approach is modeled after the scheme used in the constant-speed generators on aircraft engines. The design weight for the aux/dual power unit is approximately 1000 pounds, though weight can vary depending upon rated horsepower specified/required for individual generator applications. More than 80% of the unit's weight will be in the base unit (engine and hydraulic pump). The auxiliary engine will be located at the base of the main power generation cab of the wind powered electrical generator and supply locomotive force to the main generator shaft via a hydraulic pressure to a viscous planetary (reduction gear) system (FIG. #2, page 31), by way of a ring and pinion gearset commonly used in automotive applications. One other method of supplying torque to turn the mainshaft will be through a scaled hydraulic turbine, connected directly to the mainshaft. The planetary gearing system and a viscous coupling system, very much like the power distribution system on a full-time all-wheel drive set-up employed on some sports utility vehicles, allows the auxiliary engine to engage and maintain generator shaft speed when needed and disengage when wind velocity is sufficient to turn the generator shaft. This approach will save fuel and engine wear when the auxiliary power supply isn't needed to turn the main shaft and generate a constant supply of electricity. Inclusion of the planetary gear system is important to the overall design, because the planetary gear assembly multiplies the torque generated by the hydraulic power unit (power head) by a factor of six to ten (6× to 25×), permitting a much smaller aux power assembly to be used in very broad applications, lowering initial and sustained operating costs.

### BRIEF DESCRIPTION OF THE SEVERAL VIEWS OF THE DRAWING

(FIG. #1, page 30), depicts a cross section of the entire device, showing the propeller on the front of the wind turbine and the secondary hydraulic propulsion unit mounted on the rear of the generator.
the counterbalancing flywheel—which serves two purposes: 1) provides a connection interface between the electrical generator and, 2); acts as a harmonic damper, counteracting and smoothing out start-up/shut-down power impulses as it is applied to the generator.
the main shaft connecting the propeller to the electricity generator and via the flywheel, viscous coupling box and planetary gear set to the secondary hydraulic unit.
electric power generator; self explanatory.
auxiliary generator propulsion system (secondary hydraulic unit), turns the generator main shaft when there is insufficient wind to do so.
gear box connecting the propeller to the electric generator; provides a mechanism to vary generator main shaft speed to obtain rated electric output.
mounting assembly used to secure the generator assembly to the main support mast.
mounting assembly used to secure the auxiliary engine and drive train to the electric generator and main support mast.
generator propeller, harnesses the wind to turn the main generator shaft.
main support mast, secured in the earth and used to elevate the entire generator assembly to optimal performance elevation.
viscous coupling/power transfer case and engage/release clutch; transmits power from the secondary hydraulic unit to the connecting yoke fitted to the main shaft opposite the propeller; the viscous coupling is very similar to ones found in full-time all wheel drive vehicles, except that it is scaled in size to fit the application. The clutch engages and disengages the viscous coupling/transfer case allowing slippage and play as necessary between the main shaft and the auxiliary engine so that the propulsion unit freewheels when not needed (i.e., sufficient wind velocity is available to turn the generator).
propeller speed governor and feathering mechanism; used to maintain constant propeller speed and also flatten (feather) propeller blades when wind velocities exceed rated speed capability of the propeller assembly.
primary coupling unit; a machined steel piece with rubber dampers that connects the electric generator (via the viscous coupling and planetary gearset) to the secondary hydraulic unit.

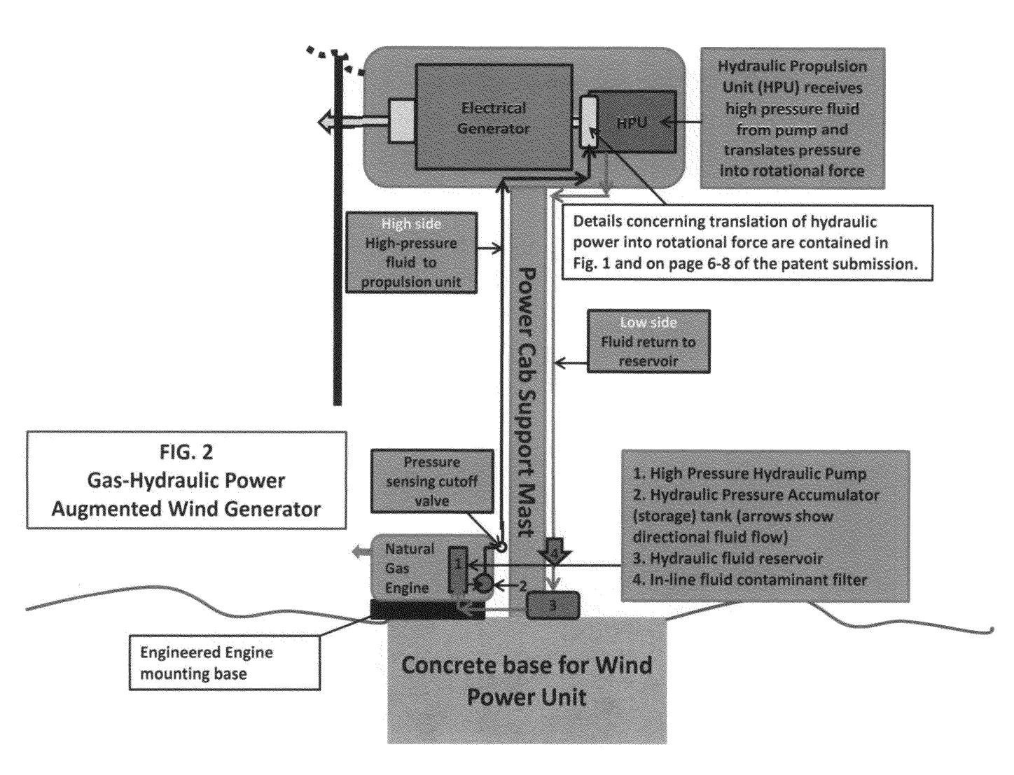

(FIG. 2, page 31), illustrates the viscous clutch and planetary gear assembly that connects the secondary hydraulic unit to main power generation shaft and acts as a torque multiplier as well as other design details, such as the flywheel—which is a harmonic damper, smoothing out the instantaneous hydraulic power as it is applied (start/stop action) to the generator. Also shown are the hydraulic supply and return lines and unit mounting system. The technical drawing also shows the solid-state auto-start/stop sensors and switches mounted on the mainshaft to control engage/disengage actions as necessary to augment the wind powered generator.
autostart/stop sensors; the assembly uses two sensors mounted at opposite ends of the main generator shaft. Each sensor monitors generator shaft speed and sends a condition signal to the start/stop switch to start or stop the auxiliary engine (mounted at the base of the support mast), when operating parameters (values) programmed into the engine controller have been reached.
flywheel; a harmonic damper, that smoothes out power impulses produced by the secondary hydraulic unit as it is turns the main shaft and the electric generator.
viscous coupling & clutch/gear box; see definition given on page 15.
auto start/stop switch; contains the various solenoids and circuit boards necessary to start or stop the natural gas powered auxiliary engine and functions very much like the ignition switch in an automobile.
auxiliary powerplant, fueled by compressed natural gas and sized to produce horsepower as required to spin the electric generator at rated RPM.
viscous clutch and planetary gear assembly that connects the secondary hydraulic unit to main power generation shaft and acts as a torque multiplier as well as other engine details, such as the flywheel—which is a harmonic damper, smoothing out the hydraulic power as it is applied to the generator. Also shown are the hydraulic supply and return lines and mounting system. The technical drawing also shows the solid-state auto-start/stop sensors and switches mounted on the engine to control engage/disengage actions as necessary to augment the wind powered generator.
autostart/stop sensors; the assembly uses two sensors mounted on opposite sides of the main generator shaft. Each sensor monitors generator shaft speed and sends a condition signal to the start/stop control module and associated ignition switch that starts or stops the auxiliary engine, based upon operating parameters (values) programmed into the engine controller.
flywheel; a harmonic damper and connection point designed to smooth out torque spikes associated (impulses) with start/stop of the hydraulic propulsion unit as it is turns the main shaft and the electric generator.
viscous coupling & clutch/gear box; see definition given on page 12.
auto start/stop switch; contains the various solenoids and circuit boards necessary to start or stop the engine and functions very much like the ignition switch in an automobile.
auxiliary powerplant, fueled by compressed natural gas and sized to produce horsepower as required to spin the electric generator at rated RPM.
engine controller; monitors auxiliary engine operating parameters (temperature, RPM, oil pressure, etc.) to maintain optimal speed and fuel consumption. Also capable of sending maintenance and repair data as necessary via satellite uplink.
planetary gear assembly; the planetary gear assembly multiplies the torque generated by the aux engine by a factor of six to ten (6× to 10×), permitting a much smaller aux engine to be used in broad applications, lowering initial and operating costs.
start/stop control module.

### DETAILED DESCRIPTION OF THE INVENTION

Design will incorporate an efficient natural gas powered engine, driving a hydraulic power unit mounted behind the power generation assembly (on the aft or non-wind end of the power cab) as an alternate locomotive source to turn the wind-powered electrical generator. The entire auxiliary propulsion system would consist of: 1) a natural gas engine; 2) a high pressure hydraulic pump driven by the natural gas powered engine; 3) a pressure accumulation (storage) tank with associated check and release valves calibrated to the pressure range required to power the propulsion unit; 4) a particulate filter to remove foreign matter from the fluid as it flows through the closed-loop hydraulic system to the reservoir for use by the hydraulic pump; 5) a control panel linked to the sensors mounted on the main generator shaft, and; 6) a hydraulic propulsion system connected to the hydraulic pump via high-pressure lines (hydraulic fluid supply and return). Items 1 through 4 would be mounted at the base of the wind turbine assembly. Item 5 would be mounted inside the base unit. Item 6 (the natural gas engine driven hydraulic pump/hydraulic propulsion system) is mounted inside the power generation cab on top of the elevation mast.

The natural gas engine drives the hydraulic pump which propels hydraulic fluid through a high-pressure connecting line. The hydraulic fluid goes directly to the hydraulic drive motor on the generator. The hydraulic accumulator (which is located in the ground-level building) has a membrane or piston separating the air and oil side, and acts as a pressure pre-load system, and overflow outlet for fluid and back-up supply source. A variable-displacement hydraulic motor mounted inside the power cab (atop the mast) employs a swashplate control and return valves to increase inherent system control and in some applications, may obviate the need for a separate viscous coupling. A water to oil heat exchanger assembly will be integrated into the hydraulic fluid return line to maintain hydraulic fluid temperatures within specified limits. The heat exchanger will be mounted alongside the radiator, which cools the natural gas engine.

Another advantage of using swashplate control and return valves is that these control mechanisms would allow the mainshaft to “freewheel” in the depressurized (0 swashplate angle) mode, reducing hydraulic fluid cooling requirements and overall drag on the system when under wind power. Similar control schemes are used in hydraulic systems and hydraulic-driven electrical generators in used in the constant-speed generators employed on many aircraft engines. A one-way check valve calibrated to the specific pressure needed by the propulsion unit will act as a safety override mechanism that shuts off hydraulic fluid flow from the pump if maximum pressure thresholds are exceeded. The check valve and incorporated pressure sensor simultaneously sends a cut-off signal to the natural gas engine to prevent damage to the accumulator tank and hydraulic lines from over-pressurization. The check valve will be incorporated on the pressure supply line.

The combination of the constant-pressure, variable-displacement hydraulic pump on the gas engine, with the constant-speed, variable-displacement hydraulic drive motor, each with individual controllers, would take care of all but the most excessive load/speed transients. The clutch/controller on the planetary gear set will act as a secondary mechanism to compensate for engagement load/speed transients above 150% of design load capacity (when the hydraulic motor is engaging and disengaging). Sudden, high-pressure shocks to the various connection joints and propulsion system could cause instantaneous component failure (metal fatigue or shearing) and certainly would reduce the service life of critical components. To ensure that hydraulic fluid used in the closed-loop system remains free of contaminants, an inline filter will be mounted on the return line as part of the base unit assembly—for ease of maintenance.

The hydraulic propulsion system will consist of a ring and pinion gear assembly, planetary gearbox to increase torque, viscous coupling and harmonic damping flywheel to absorb start/stop engine shock and sensors to monitor shaft speed. The ring gear is impelled by the rotation of the pinion assembly, which translates hydraulic pressure into (right angle) rotational force. The pinion translates right angle motion into torque which spins the ring gear which, in turn, spins the planetary gear assembly. The ratios for the planetary gear set may be varied as required to provide sufficient torque to spin the main generator shaft at specified RPM to meet specified output demand (rated power or peak usage demand). The entire hydraulic propulsion system, including the natural gas engine, is controlled by a series of speed sensors and auto start/stop actuators synchronized, programmed and controlled by the Master Control Panel to work in unison.

The hydraulic propulsion system would automatically send power via a viscous coupling and planetary gear set that engage and turn the electrical generator shaft when wind velocity isn't sufficient to ensure that main shaft revolutions per minute (RPM) remain within generator manufacturer's recommended speed range (minimum speed necessary to generate rated electrical output). The most likely condition causing the auxiliary propulsion system to engage would be insufficient wind velocity (calm days) or gusting velocities that exceed rated rotational speed of the propeller assembly (unpredictable weather/storm conditions), which would fail to turn the main generator shaft at the required RPM to assure specified/rated electrical output. A propeller feathering mechanism could also be incorporated to prevent damage to the large propeller assembly during extremely high winds (storm conditions).

The auxiliary propulsion system would be controlled by employing the latest technology available (sensors, controllers and actuators) that have accrued hundreds of thousands of hours of all-weather use in automotive and aircraft industry applications. Symmetrical sets of sensors, controllers and actuators would be mounted within a control box co-located with the natural gas engine and the hydraulic propulsion unit at the power generator base. The other set of sensors will be mounted on the hydraulic propulsion unit and generator main shaft in the power generation cab atop the mast assembly. All sensors will be capable of calibration to specific generator/applications, as needed and form integral components of the redundant system for shaft speed monitoring and control. The matched (paired) shaft-mounted components sense decreases in speed and provide commands to the natural gas engine/high-pressure hydraulic pump to engage, begin spinning the pinion gear and thusly rotate the ring gear, which is connected to the planetary gear assembly, which in-turn, propels the main shaft axially in absence of wind. This apparatus ensures instantaneous “on demand” power augmentation to maintain generator shaft RPM in the optimal electricity generating range (peak demand satisfaction or rated output) specified by the generator manufacturer. The sensors and actuators used are extremely rugged, small and have the added benefit of drawing very low voltage when in operation (12v DC).

If the generator shaft RPM drops below the lowest acceptable RPM for demand/rated power generation (250 RPM, for example), a series of redundant electro-magnetic induction (shaft) speed sensors mounted on the generator main shaft (FIG. #2, page 31) would immediately sense a reduction in shaft speed to below the calibrated rotational speed range and transmit an electrical signal to the main hydraulic propulsion system control unit, thereby triggering the natural gas powered aux engine to start-up, come on line and spin the hydraulic pump unit which would then provide a pre-specified volume of high-pressure hydraulic fluid via a delivery line to the hydraulic power unit mounted on center-line axis behind the electrical power generator.

The hydraulic pressure supplied to the power unit via the hydraulic pump would be translated into rotational force via a pinion and ring gear set or via a vaned turbine unit mounted on the generator mainshaft that is turned directly by hydraulic pressure from the hydraulic pump line. The vaned turbine unit would be a more compact and economical approach for low to medium power generation (10 kW to 100 kW range), while the ring and pinion application would be more suitable to megawatt range power generation requirements, because the gearset can be stepped as needed to match torque requirements to spin the electrical generator at the specified revolutions per minute (RPM) to produce rated electrical output.

The pinion gear would engage and turn the axially mounted ring gear which provides rotational force (torque) to the planetary gear system, viscous coupling box and damping flywheel. The aux engine and generator mainshaft will be fitted with electromagnetic (induction) rotational speed sensors and auto-start/stop technology (FIG. #2, page 31), that is very similar to the sensors and controller mechanisms currently employed in hybrid electric-gas automobiles to instantly start-up, engage and then cut-off when not needed, as well as activate and deactivate natural gas engine cylinders for optimum economy of operation during periods of light power demand by the electric generator.

This apparatus ensures instantaneous “on demand” power augmentation to maintain generator shaft RPM in the optimal electricity generating range (peak demand satisfaction or rated output) specified by the generator manufacturer. The sensors and actuators used are extremely rugged, small and have the added benefit of drawing very low voltage when in operation (12v DC).

Other key design features:
1. Performance
   Natural Gas/Compressed Natural Gas (NG/CNG) Fuel
   High torque
   Low emissions, meeting CARB/EPA standards or better
2. Licensed Proprietary Controller (from Industrial controller Supplier)
   Programmable electronic feature including cruise control, max RPM speed, PTO, engine protection, and diagnostic capability
3. Fuel and System (state-of-the-art industrial/automotive, e.g.)
   Electronically controlled gaseous delivery management system
   Fuel economy comparable to or better than diesel engines of similar output
   Extended maintenance intervals
   Lean burn, Closed Loop Adaptive Learn Technology
   Electronically controlled wastegate turbocharger
   CARB/EPA emission certified for use in 50 states
   CARB optional low 1.2 g/bhp-hr NOx+NMHC for MHHD, HHDD

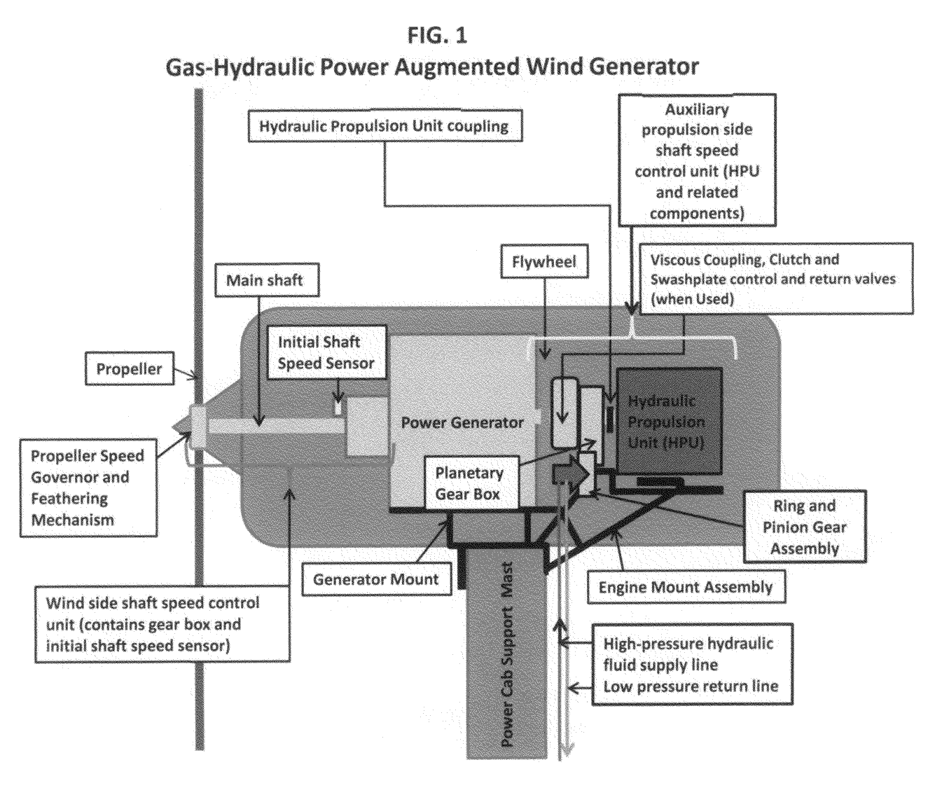

IV. Uses an aircraft style suspension mount (FIG. 1, hydraulic power unit mounting plate, page 30) to hang the power unit off the rear of the wind generator assembly and also correctly align the engine with the main power shaft;

V. Uses an automotive or industrial “on-demand” auto-start/cut-off switch), (FIG. #2, page 31), permitting the engine to instantaneously engage and supply hydraulic pressure when needed and also rapidly cut-off as wind conditions warrant;

VI. Employs a shaft speed sensing switch (FIG. #2, page 31), triggering the auto-start mechanism and engaging the engine/hydraulic fluid pump assembly to maintain adequate main shaft RPM when wind velocity isn't adequate to turn the generator;

VII. Uses a planetary drive and start-stop shock mitigating viscous clutch (FIG. #2, page 31), allowing the engine power supply shaft to freewheel without creating shaft drag when not needed;

VIII. Engine horsepower will be matched to the application and will depend upon size of the hydraulic pump and pressure/fluid velocity necessary to propel the wind generator and region of the country where deployed.

Typical electro-magnetic sensors calibrated to preset shaft speeds as described in Section 7 on page 15 and in (FIG. #2 on page 31), as attached to this submission.

Sensors detect shaft speed and send signals to control unit which then starts or stops the auxiliary engine as required.

1. Modifying megawatt range wind powered electric generators to add a Natural Gas (NG) or similarly fueled auxiliary power source increases the reliability and predictability and thus the relevance of wind power as a viable and renewable part of our national power grid. Leveraging all available “clean technologies” is absolutely vital to reduce our national energy dependence upon dirty sources of electrical power (coal fired power plants, for example). The Department of Energy's Energy Use Institute has documented that wind power coupled with natural gas power augmentation emits less than 10% of the Nitrous Oxides, Sulfur Dioxide, Carbon Dioxide and other pollutants produced by burning “clean coal” to generate electricity. Combining a NG powered auxiliary engine with a wind generator yields a system which can be more widely deployed nationally (outside of constant high-wind areas), while generating clean electricity using America's abundant supply of natural gas to augment wind power when it is needed.
